(19) United States
(12) Patent Application Publication
(10) Pub. No.: US 2006/0223471 A1
(43) Pub. Date: Oct. 5, 2006

(54) Receiver having a gain cancelling amplifier

(76) Inventors: Scott T. Dupuie, Lakeway, TX (US); Charles D. Thompson, Buda, TX (US); Andrew W. Dornbusch, Austin, TX (US)

Correspondence Address: TROP PRUNER & HU, PC, 1616 S. VOSS ROAD, SUITE 750, HOUSTON, TX, 77057-2631, US

(21) Appl. No.: 11/093,863

(22) Filed: Mar. 30, 2005

(51) Int. Cl. H04B 1/06; H04B 7/00

(52) U.S. Cl. 455/234.2

(57) ABSTRACT

A technique includes applying a first gain to a first radio frequency signal to generate a second radio frequency signal, and the technique includes generating an intermediate frequency signal in response to the second radio frequency signal. In response to a change occurring in the first gain, a second gain that is applied to the intermediate frequency signal is changed to cancel at least some of the change in the first gain.

### BACKGROUND

The invention generally relates to a receiver that has a gain canceling amplifier.

Subscriber-based satellite radio, ever-increasing in popularity, may be installed in a wide variety of mobile equipment, such as motor vehicles, watercrafts, portable music players, airplanes, etc. FIG. 1 depicts a typical equipment package for mobile satellite radio, a package that includes an active antenna 5 and a satellite radio receiver 10. The active antenna 5 includes an antenna element 6 and a low noise amplifier (LNA) 7. In response to received electromagnetic radiation, the antenna element 6 produces a radio frequency (RF) signal that is amplified by LNA 7. This amplified RF signal propagates over an antenna feedline 8 to the receiver 10.

The receiver 10 may be, for example, a superheterodyne receiver that includes an LNA 12, which receives the RF signal from the antenna feedline 8. The strength of the RF signal that is received by the LNA 12 may momentarily decline due to temporary satellite signal blockages that are caused by buildings, trees, rain, hills, etc.; and the strength of the received RF signal may momentarily increase due to the presence of high power terrestrial repeaters that are located strategically throughout urban areas. As a result of the varying strength of the received RF signal, the LNA 12 typically has a variable gain for purposes of regulating the strength of the RF signal that is processed by the other circuitry of the receiver 10.

As depicted in FIG. 1, the LNA 12 provides its output signal to an RF mixer 14, a device that translates a selected RF channel of the RF signal to a predetermined intermediate frequency (IF). A bandpass filter (BPF) 18 that is centered at this predetermined IF receives the translated signal from the RF mixer 14 and provides an IF output signal that has significant spectral energy in a passband that is centered around the predetermined IF. Thus, the BPF 18 significantly attenuates spectral energy in a stopband outside of the passband.

The IF signal from the BPF 18 is received by an IF mixer 20 of the receiver 10. The IF mixer 20 translates the selected channel (now centered at the predetermined IF) to a baseband frequency. The signal that appears at the output terminal of the IF mixer 20 may be amplified by an LNA 21 before being provided to a lowpass filter (LPF) 24. The output terminals of the LPF 24, in turn, provide an analog baseband signal (called “V_{OUTBB}”) that is further processed by baseband circuitry (not depicted in FIG. 1) for purposes of demodulating the baseband signal to recover the satellite radio content.

### SUMMARY

In an embodiment of the invention, a technique includes applying a first gain to a first radio frequency signal to generate a second radio frequency signal, and the technique includes generating an intermediate frequency signal in response to the second radio frequency signal. In response to a change occurring in the first gain, a second gain that is applied to the intermediate frequency signal is changed to cancel at least some of the change in the first gain.

In another embodiment of the invention, a technique includes controlling a gain of an amplifier in a radio frequency section of a receiver in response to a strength of a radio frequency signal. The technique includes inversely varying a gain of an amplifier in an intermediate frequency section of the receiver with respect to a variation in the gain of the amplifier in the radio frequency section of the receiver.

In another embodiment of the invention, a receiver that is associated with a first radio service provider includes a radio frequency section and an intermediate frequency section. The radio frequency section determines the strength of spectral energy that is received from the first radio service provider and regulates the gain of a first amplifier of the radio frequency section in response to the determined strength. The determined strength is capable of being in error due to reception of additional spectral energy that is associated with a second radio service provider. The intermediate frequency section includes a second amplifier. The second amplifier has a gain that inversely varies with respect to a variation in the gain of the first amplifier to reduce an overall gain sensitivity of the receiver to the additional spectral energy that is associated with the second radio service provider.

Advantages and other features of the invention will become apparent from the following drawing, description and claims.

### BRIEF DESCRIPTION OF THE DRAWING

FIG. 1 is a block diagram of a satellite radio receiver system of the prior art.

FIG. 2 depicts exemplary spectral energy present in a received radio frequency signal.

FIG. 3 depicts a flow diagram illustrating a technique to reduce the sensitivity of a receiver to out-of-band spectral energy according to an embodiment of the invention.

FIGS. 4 and 8 are schematic diagrams of wireless receiver systems according to embodiments of the invention.

FIG. 5 depicts a gain versus control signal relationship of an amplifier in a radio frequency section of the receiver of FIG. 4 according to an embodiment of the invention.

FIG. 6 depicts a gain versus control signal relationship of an amplifier in an intermediate frequency section of the receiver of FIG. 4 according to an embodiment of the invention.

FIG. 7 depicts a noise figure versus gain in the intermediate frequency section of the receiver of FIG. 4 according to an embodiment of the invention.

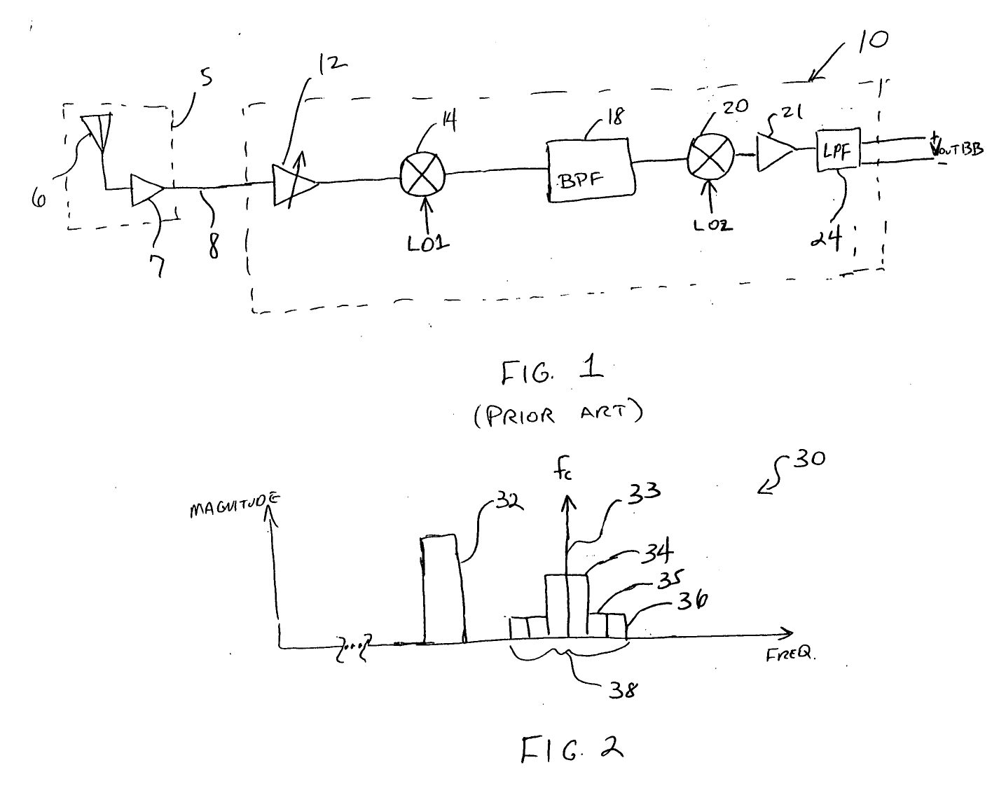

### DETAILED DESCRIPTION

In accordance with embodiments of the invention, a radio receiver is disclosed herein. For purposes of simplifying the following description, it is assumed unless otherwise stated that the disclosed radio receiver is a satellite radio receiver. However, a satellite radio receiver is used to illustrate one out of many different types of radio receivers in accordance with the various embodiments of the invention. Thus, the appended claims cover receivers (cellular telephone receivers and frequency modulation (FM) receivers, as just a few examples) other than satellite radio receivers.

The radio receiver receives a radio frequency (RF) signal that contains spectral energy (herein called “in-band spectral energy”) from an associated satellite radio service provider. The in-band spectral energy may be transmitted by one or more geosynchronous satellites and possibly one or more terrestrial repeaters.

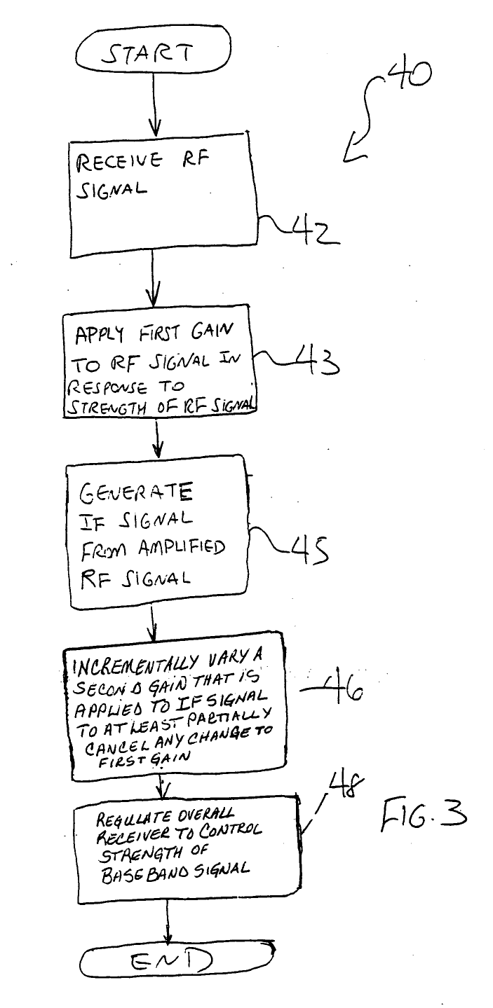

As a more specific example, FIG. 2 depicts exemplary spectral energy 30 that may be present in an RF signal that is received by a satellite radio receiver. The spectral energy 30 includes in-band spectral energy 38 that is broadcast over a channel that is associated with a particular satellite service provider (herein called the “first satellite radio service provider”) and is processed by the receiver for purposes of recovering satellite radio content that is broadcast by the provider. As depicted in FIG. 2, the in-band spectral energy 38 may be generally centered around a RF channel frequency (called “fc”) and may include spectral energy that is provided by the transmission(s) from one or more geosynchronous satellites and possibly from one or more terrestrial repeaters. For the specific spectral energy that is shown in FIG. 2, the in-band spectral energy 38 includes spectral components 35, 36 and 34 that are associated with a first geosynchronous satellite, a second geosynchronous satellite and a terrestrial repeater, respectively.

As described further below, the satellite radio receiver that is disclosed herein determines the power that is contained in the in-band spectral energy 38 to determine the relevant strength of the received RF signal. From the determined strength, the satellite radio receiver controls a gain that is applied to the received RF signal for purposes of accommodating variations in the in-band spectral energy 38 and thus, regulating the strength of the RF signal that is processed by the receiver.

Thus, the satellite radio receiver applies relatively less gain to the received RF signal when the receiver determines that the in-band spectral energy 38 is relatively high, and the satellite radio receiver applies relatively more gain when the receiver determines that the in-band spectral energy 38 is relatively low.

It has been discovered that the receiver's determination of the spectral strength of the in-band spectral energy 38 may be affected by out-of-band energy, otherwise called an “out-of-band blocker 32” (FIG. 2) herein. The out-of-band blocker 32 may be, for example, spectral energy that is associated with a second satellite radio service provider that broadcasts satellite content, which is not recovered via the disclosed satellite radio receiver. Although (as further described below) the satellite radio receiver eventually filters the out-of-band blocker 32 from the processed signal, when making a determination of the strength of the in-band spectral energy 38, the out-of-band blocker 32 may contain a relatively significant amount of spectral energy that is introduced into this determination.

The presence of a relatively strong out-of-band blocker 32 (as compared to the strength of the in-band spectral energy 38) may effectively cause missed reception of satellite radio content from the first satellite service provider, if not for the features that are described herein.

Certain environments may cause the in-band spectral energy 38 to be relatively weak, as compared to the out-of-band blocker 32. For example, the satellite radio receiver may be mounted in a mobile object, such as an automobile, which is momentarily in a position in which the out-of-band blocker 32 may be significantly stronger than the in-band spectral energy 38. For example, the automobile may be in proximity to a terrestrial repeater that is associated with the second satellite radio provider, and thus, the out-of-band blocker 32 may be relatively strong. However, at this position of the automobile, the in-band spectral energy 38 may be relatively weak. Thus, the in-band spectral energy 38 may (for this example) need a significant boost by the satellite radio receiver for purposes of ensuring adequate recovery of the corresponding satellite radio content. However, due to the out-of-band blocker's interference with the satellite radio receiver's determination of signal strength, the satellite radio receiver may incorrectly determine that the in-band spectral energy is quite large and thus, may apply an insufficient gain to the received RF signal, possibly resulting in poor or missed reception of content from the first satellite radio service provider.

To accommodate the above-described scenario, a technique 40 that is depicted in FIG. 3 may be used in conjunction with a satellite radio receiver in accordance with embodiments of the invention. The technique 40 includes receiving an RF signal, as depicted in block 42. A gain is applied to the RF signal in response to the determined strength of the RF signal, as depicted in block 43. The gain that is applied to the RF signal typically varies over time due to corresponding variations in the strength of the incoming RF signal. As mentioned above, this determined signal strength may be prone to error due to a relatively strong out-of-band blocker that is close in frequency to the selected RF channel. However, the technique 40 includes additional steps to ensure that sufficient amplification is applied to the processed signal.

More specifically, in block 45, the technique 40 includes generating an intermediate frequency (IF) signal from the amplified RF signal. Subsequently, a second gain that is applied to the IF signal is incrementally changed to at least partially cancel any change to the first gain, as depicted in block 46. This cancellation ensures that after the out-of-band blocker 32 is filtered out by the IF section of the receiver, the receiver system may then recognize the actual in-band spectral strength and adjust the gain accordingly.

As a more specific example, due to reception of a relatively strong out-of-band blocker 32, the satellite radio receiver may determine (incorrectly) that a relatively weak in-band spectral energy 38 is instead strong, and as a result, the satellite radio receiver may reduce the gain that is applied to the received RF signal by −10 decibel (dB) gain (i.e., the receiver may apply a negative incremental gain). Continuing the example, the satellite receiver, after producing the IF signal, then applies the inverse incremental gain, a gain of +10 dB (i.e., a positive incremental gain) to the IF signal to effectively cancel out the initial decrease in gain by the satellite radio receiver.

Thus, in some embodiments of the invention, the incremental gains that are applied in blocks 43 and 46 of FIG. 3 cancel each other out so as to provide an effective incremental gain of unity between the two blocks 43 and 46. The satellite receiver controls the overall gain of the receiver (and thus, effectively controls the overall incremental adjustment to the receiver's gain) through the use of one or more additional amplifiers for purposes of controlling the strength of the baseband signal, as depicted in block 48 of FIG. 3.

Thus, the technique 40 that is depicted in FIG. 3 achieves a redistribution of gain in the satellite radio receiver. This redistribution of gain, in turn, compensates for the in-band spectral energy that is perceived in the RF section of the satellite radio receiver versus the in-band spectral energy that is perceived in the IF section of the satellite radio receiver. Without the above-described redistribution of gain within the satellite radio receiver, the RF section of the receiver may unduly attenuate the received RF signal so that the attenuated in-band spectral energy falls below the noise floor of the baseband signal. As noted above, the techniques that are disclosed herein, such as the redistribution of gains, may be used in non-satellite radio receivers, in other embodiments of the invention.

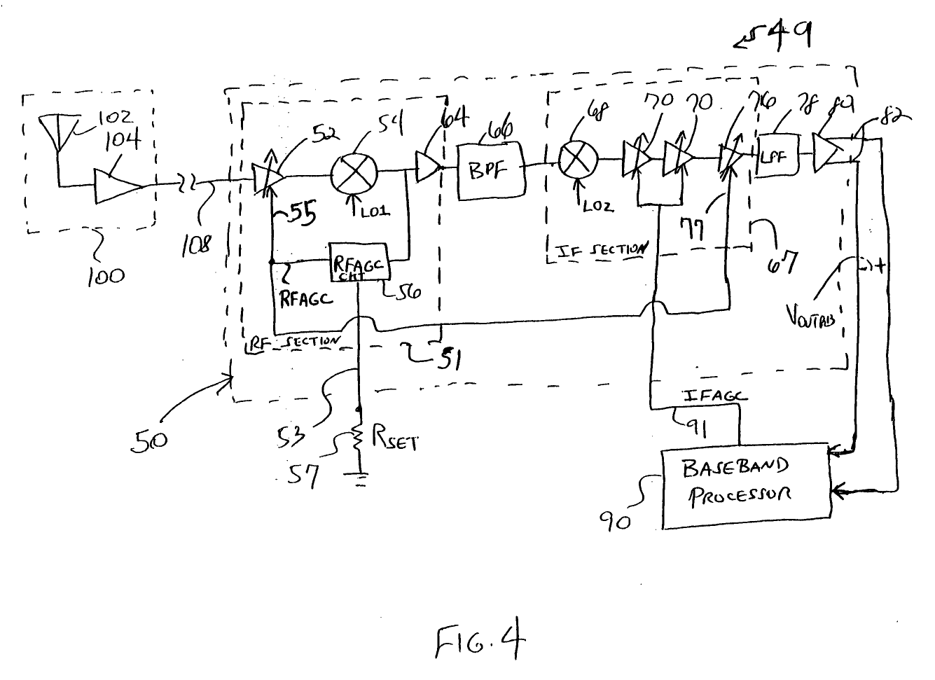

As a more specific example, FIG. 4 depicts a satellite radio receiver system 49 in accordance with an embodiment of the invention. The satellite radio receiver system 49 includes an active antenna 100 that produces an RF signal in response to electromagnetic radiation that is received from one or more geosynchronous satellites and possibly one or more terrestrial repeaters. At least some of this electromagnetic radiation contains in-band spectral energy from a satellite radio service provider that is associated with the satellite radio receiver system 49.

The active antenna 100 includes an antenna element 102 that is coupled to a low noise amplifier (LNA) 104 of the active antenna 100. In some embodiments of the invention, the LNA 104 provides a fixed amplification gain to the received RF signal to drive an antenna feedline 108. The antenna feedline 108 communicates the received RF signal to a dual conversion, superheterodyne satellite radio receiver 50 of the satellite radio receiver system 49. The satellite radio receiver 50 includes an RF section 51, an IF section 67 and a bandpass filter (BPF) 66 that generally separates the RF 51 and IF 67 sections.

It is noted that a superheterodyne receiver is one out of many possible architectures for the receiver 50 in accordance with the various embodiments of the invention, as the gain management control that is described herein may be applied regardless of the number of mixers in the receiver's topology. Thus, in other embodiments of the invention, the receiver may be single superheterodyne receiver or a triple superheterodyne receiver, as just a few additional examples.

The RF signal that is provided by the antenna feedline 108 is received and amplified by a variable gain LNA 52 of the RF section 51. This gain may be a positive or a negative gain, depending on the determined strength of the in-band spectral energy of the received RF signal. Thus, in the context of this application, the application of a “gain” to a signal may refer to the amplification as well as the attenuation of the signal.

The RF section 51 regulates the gain of the LNA 52 in response to the RF section's determination of the power that is contained in the in-band spectral energy. As depicted in FIG. 4, in some embodiments of the invention, this determination is made by an RF Automated Gain Control (RFAGC) circuit 56 of the RF section 51, a circuit that generates a control signal (called “RFAGC”) that is received by a gain control terminal 55 of the LNA 52 for purposes of regulating the gain of the LNA 52.

In some embodiments of the invention, the RFAGC circuit 56 may determine the gain for the LNA 52 in direct response to the signal that appears at the output terminal of the LNA 52. However, as depicted in FIG. 4, in other embodiments of the invention, the RFAGC circuit 56 determines the gain for the LNA 52 in response to a determination of the in-band power that is present in a signal that appears at the output terminal of an RF mixer 54 of the RF section 51.

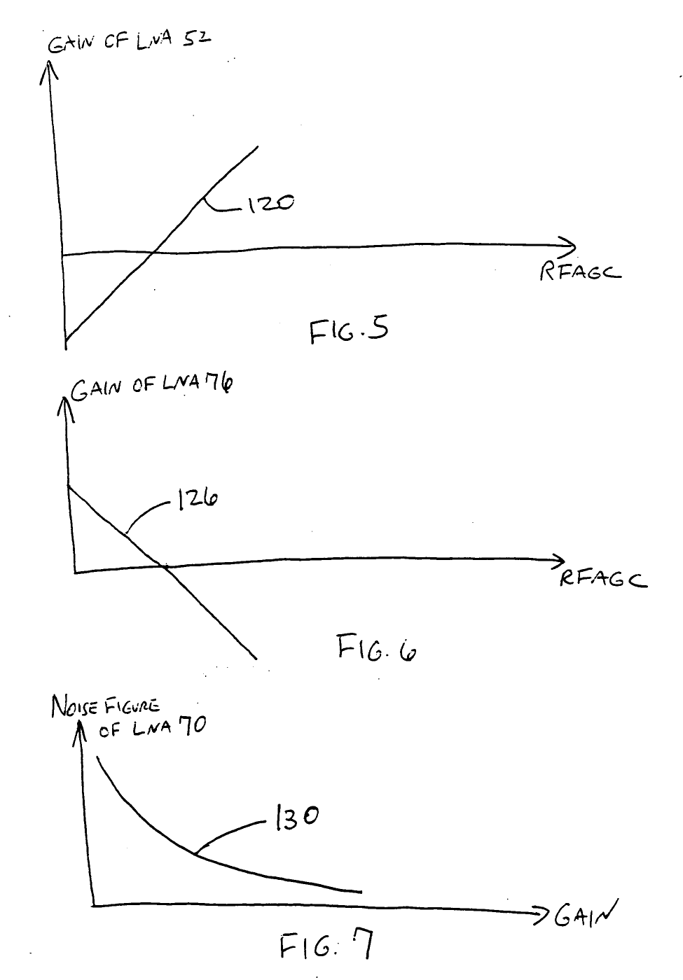

The signal input terminal of the RF mixer 54 receives an RF signal from the output terminal of the LNA 52. The RF mixer 54 translates a selected in-band channel of this RF signal to a predetermined IF. As shown in FIG. 5, in some embodiments of the invention, the RF mixer 54 receives a local oscillator signal (called “LO₁”), which is a sinusoidal signal that has a frequency to translate the selected RF channel to a predetermined IF.

In some embodiments of the invention, the RF mixer 54 may be an image reject mixer that converts the LO₁ local oscillator signal into a pair of quadrature signals, i.e., a cosine signal and a sine signal that each has the same frequency as the LO₁ signal but are 90° out of phase with respect to each other. The RF mixer 54 amplifies each quadrature signal with the signal from the LNA 52 to form signals that drive a polyphase filter of the RF mixer 54. The polyphase filter, in response to these signals, translates the selected RF channel to the predetermined IF and rejects the inherent image that is produced by this translation. Other topologies for the RF mixer 54 are possible, in other embodiments of the invention.

Among the other features of the RF section 51, a fixed, or constant, gain amplifier 64, in some embodiments of the invention, receives the translated RF signal from the output terminal of the RF mixer 54 and drives the BPF 66. Additionally, in some embodiments of the invention, the desired power for the in-band spectral energy may be set by a resistor 57 that is coupled to a terminal 53 of the RFAGC circuit 56. Thus, a resistance (called “RSET”) of the resistor 57 may be selected to set the desired power.

To summarize the operation of the RF section 51, in accordance with some embodiments of the invention, the RF section 51 receives and amplifies (via the LNA 52) an incoming RF signal in response to the RF section's determination of the strength of the in-band spectral energy. To achieve this, the RF section 51 includes a control loop within the RF section 51 for purposes of regulating the gain of the LNA 52. This control loop may adjust the gain of the LNA 52 by an incremental positive amount or by an incremental negative amount, depending on whether the RFAGC circuit 56 detects a decrease or an increase in the strength of the incoming RF signal.

The BPF 66 receives the RF signal from the RF section 51 and establishes a passband about the predetermined IF. Therefore, the signal that appears at the output terminal of the BPF 66 has spectral energy that is concentrated within this passband, and spectral energy outside of this passband is significantly attenuated. Thus, the BPF 66 provides an IF signal that has spectral energy that is centered about the predetermined IF to the IF section 67.

The IF section 67 of the satellite radio receiver 50 includes a variable gain amplifier 76 that is located in the IF signal path to at least partially cancel the incremental gain that is applied by the LNA 52 of the RF section 51. More specifically, in some embodiments of the invention, incremental changes in the gain of the amplifier 76 inversely mirrors incremental changes in the gain of the LNA 52. Therefore, as a more specific example, if the gain of the LNA 52 changes by −10 dB, then the gain of the amplifier 76 changes inversely by +10 dB to effectively cancel the gain that is applied by the LNA 52. To accomplish this, the amplifier 76 has a gain control terminal 77 that receives the RFAGC signal from the RFAGC circuit 56. The amplifier 76, in some embodiments of the invention, responds to the RFAGC signal in a manner that varies inversely to the response of the LNA 52 to the RFAGC signal.

For example, referring to FIGS. 5 and 6 in conjunction with FIG. 4, in some embodiments of the invention, the gain of the LNA 52 may have a linear relationship 120 (FIG. 5) to the RFAGC signal. Thus, for example, the relationship 120 may be mathematically viewed as having a particular slope and a y-intercept on the gain axis. As depicted in FIG. 6, a relationship 126 between the gain of the amplifier 76 and the RFAGC control signal inversely varies with the relationship 120. Thus, mathematically, the y-intercept on the gain axis for the relationship 126 is the negative of the y-intercept for the relationship 120; and the linear slope of the relationship 126 is the negative of the slope of the relationship 120.

Although the gain versus RFAGC relationships 120 and 126 are depicted as being linear, in other embodiments of the invention, these relationships may be non-linear. For example, in some embodiments of the invention, these relationships may be logarithmic and thus, the gains of the LNA 52 and the amplifier 76 may each logarithmically vary with the magnitude of the RFAGC signal. For example, each linear increment of the RFAGC signal may correspond to a corresponding dB change in the gain of the LNA. However, regardless of the specific mathematical relationship between the gains and the RFAGC control signal, the amplifier 76 has a gain that is the inverse of the gain of the LNA 52 for a given value of the RFAGC control signal.

Thus, referring to FIG. 4, in some embodiments of the invention, the amplifier 76 senses (via the RFAGC signal) the gain that the LNA 52 applies to the RF signal in the RF section 51; and in response to a variation in the gain of the LNA 52, the amplifier 76 inversely varies the gain that the amplifier 76 applies to the IF signal in the IF section 67.

Among the other features of the IF section 67, in some embodiments of the invention, the IF section 67 includes an IF mixer 68 that has an input terminal that receives the IF signal from the BPF 66. The IF mixer 68 translates the IF channel to baseband. The IF mixer 68 receives a local oscillator signal (called “LO₂”) that has a fundamental frequency to cause the above-described translation of the IF channel. Similar to the RF mixer 54, in some embodiments of the invention, the IF mixer 68 may be an image reject mixer that is similar in design to the above-described RF image reject mixer and contains circuitry to convert the LO₂ signal into quadrature signals for purposes of translating the IF channel to baseband and rejecting the corresponding image that is inherently produced by this translation.

The output of the IF mixer 68 is connected to one or more series-connected variable gain amplifiers 70 that function to control the gain of the IF signal for purposes of regulating the strength of the baseband signal that is produced by the satellite radio receiver 50.

More specifically, in accordance with some embodiments of the invention, the gain of each amplifier 70 is controlled in response to a control signal (called “IFAGC”) that is furnished by a baseband processor 90. As depicted in FIG. 4, in some embodiments of the invention, the baseband processor 90 may be separate from (located “off-chip,” for example) the satellite radio receiver 50.

The baseband processor 90 receives an analog differential baseband output signal (called “V_{OUTBB}” in FIG. 4) from the satellite radio receiver 50, and in response to the strength of the V_{OUTBB} baseband signal, the baseband processor 90 regulates (via the IFAGC control signal) the gains of the amplifiers 70. Therefore, the IF section 67 and the baseband processor 90 form a control loop that controls the IF gain based on the determined strength of the baseband signal. In some embodiments of the invention, the output terminal of the second amplifier 70 is coupled to the input terminal of the amplifier 76.

As depicted in FIG. 4, in some embodiments of the invention, the output terminal of the amplifier 76 is coupled to a lowpass filter (LPF) 78 that produces a baseband signal at its output terminal. A differential amplifier 80 has an input terminal that is connected to the output terminal of the LPF 78 for purposes of furnishing the V_{OUTBB} baseband signal at output terminals 82 of the amplifier 80.

Therefore, as can be seen from FIG. 4 in light of the discussion above, the amplifier 76 cancels the incremental gain that is applied by the LNA 52 to effectively redistribute gains within the satellite radio receiver 50; and the overall incremental change of the gain that is applied by the RF satellite receiver 50 is controlled via the baseband processor's control of the IFAGC control signal.

Due to the above-described distribution of gains in the satellite radio receiver 50, the amplifiers 70 operate at relatively high gains, as compared to a satellite radio receiver system that does not include a gain-canceling amplifier 76. More specifically, in the presence of a relatively high energy out-of-band blocker (as compared to the in-band spectral energy), the amplifier 76 cancels the attenuation that is applied by the LNA 52 so that the baseband processor 90 detects the low level in-band spectral energy and boosts the gains of the amplifiers 70 accordingly. For the scenario in which there is no high energy out-of-band blocker and the detected in-band spectral energy is relatively low, the amplifier 76 cancels the high gain from the LNA 52, and the amplifiers 70 operate at relatively high gains.

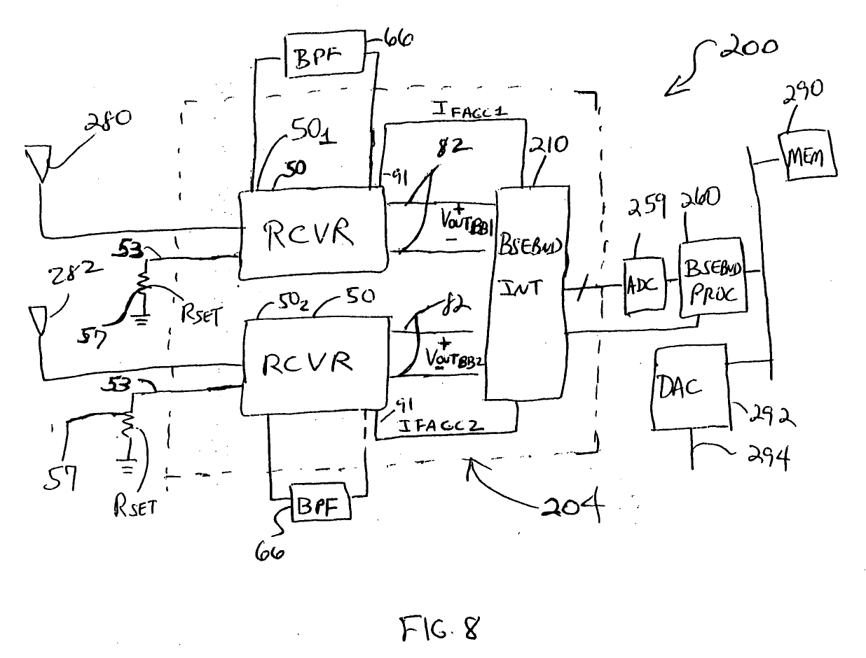

Operation of each amplifier 70 at a relatively high gain produces a better noise characteristic for the satellite radio receiver 50, in some embodiments of the invention. In this regard, referring to FIG. 7 (that depicts a relationship 130 between a noise figure of the amplifier 70 versus its gain) in conjunction with FIG. 4, in some embodiments of the invention, the noise figure of the amplifier 70 generally declines with its gain. Therefore, the overall noise figure of the satellite radio receiver 50 may be reduced due to operation of each amplifier 70 at a relatively high gain.

Amplifiers distort when they try to pass overly large signals. This distortion behaves like noise, and so reduces the effective signal-to-noise ratio of the output signal. Thus, the channel needs enough gain that the signal remains above the noise, but not so much that the distortion becomes significant. In effect, the LNA/anti-LNA combination allows dynamic redistribution gain along the channel, thereby allowing more control over the gain/linearity optimization.

Additionally, due to the above-described arrangement, the required gain control range of the VGA 70 is reduced, which relieves stability problems with the baseband AGC control loop; and by adding the anti-LNA stage the two AGC loops are now orthogonal (i.e., they do not interact).

Referring to FIG. 8, in accordance with some embodiments of the invention, a satellite radio receiver system 200 may include two satellite radio receivers 50₁ and 50₂, each of which has a similar design to the satellite radio receiver 50 that is depicted and described above in connection with FIG. 4. The satellite radio receiver system 200 is a full diversity-type receiver system in that both receivers 50₁ and 50₂ are designed to receive RF signals that are associated with the same radio satellite service provider. However, due to the physical position of antennas 280 (connected to the receiver 50₁) and 282 (connected to the receiver 50₂), the RF signals that are received by the receivers 50₁ and 50₂ may differ. Thus, in accordance with some embodiments of the invention, a baseband processor 260 of the satellite radio receiver system 200 calculates a carrier-to-noise (C/N) ratio for the baseband signal produced by each receiver 50₁ and 50₂. Based on the C/N ratios, the baseband processor 260 selects the receiver 50₁ and 50₂ that provides the strongest baseband signal for reception. As can be appreciated, during the operation of the satellite radio receiver system 200, the receiver 50₁ and 50₂ that is selected may vary, depending on the environment, orientation of the satellite radio receiver system 200, etc.

In some embodiments of the invention, the receivers 50₁ and 50₂ are part of a semiconductor package 204 and may be fabricated on the same die or on different dies, depending on the particular embodiment of the invention. The semiconductor package 204 may also include a baseband interface 210 that, as its name implies, forms an interface for communicating baseband signals and control signals between the receivers 50₁ and 50₂ and the baseband processor 260.

The baseband interface 210 and the receivers 50₁ and 50₂ may all be fabricated on the same die, in some embodiments of the invention. Furthermore, in accordance with other embodiments of the invention, the baseband processor 260 may be part of the semiconductor package 204 and may be fabricated on the same die as the receivers 50₁ and 50₂. Thus, many variations are possible and are within the scope of the appended claims.

As depicted in FIG. 8, in some embodiments of the invention, the BPFs 66 (one for each receiver 50₁, 50₂) reside outside of the semiconductor package 204. As a more specific example, each BPF 66 may be a surface acoustic waveform (SAW) filter, in some embodiments of the invention. Additionally, as depicted in FIG. 8, in some embodiments of the invention, additional components may be located outside of the semiconductor package 204, such as, for example, the resistors 57 that set the in-band spectral energy threshold, crystals (not depicted in FIG. 8) to establish reference frequencies for local oscillator signals for the receivers 50₁ and 50₂, etc.

In some embodiments of the invention, the satellite radio receiver system 200 may include an analog-to-digital converter (ADC) 259 that is coupled to the baseband interface 210 for purposes of converting the analog baseband signal that is provided by the baseband interface 210 into a digital signal to be processed by the baseband processor 260. The baseband processor 260, in turn, demodulates the digital baseband signal. The resultant demodulated signal may be stored for buffering, for example, in a memory 290 of the satellite radio receiver system 200. Thus, the memory 290 stores digital data that indicates the received satellite radio content from the associated satellite radio service provider. The memory 290 is coupled to the baseband processor 260 along with a digital-to-analog converter (DAC) 292. The DAC 292 converts the digital data stored in the memory 290 into an analog signal that appears at an output terminal 294 of the DAC 292. This analog signal, in turn, indicates the satellite radio content and may be used, for example, as the source signal for driving speakers (not depicted in FIG. 8).

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
applying a first gain to a first radio frequency signal by a first gain to generate a second radio frequency signal;
generating an intermediate frequency signal in response to the second radio frequency signal; and
in response to a change to the first gain, changing a second gain that is applied to the intermediate frequency signal to cancel at least some of the change in the first gain.

2. The method of claim 1, further comprising:
generating a baseband signal from the intermediate frequency signal; and
selectively applying additional gain to the intermediate frequency signal to regulate a strength of the baseband signal.

3. The method of claim 1, wherein the act of applying the first gain comprises:
regulating the first gain in response to a determined strength of the first radio frequency signal.

4. The method of claim 1, wherein the act of generating comprises:
mixing the second radio frequency signal with an intermediate frequency to generate a third radio frequency signal.

5. The method of claim 4, wherein the act of generating further comprises:
routing the third radio frequency through a bandpass filter centered near the intermediate frequency to generate the intermediate frequency signal.

6. The method of claim 1, further comprising:
mixing the intermediate frequency signal to translate an intermediate frequency channel of the intermediate frequency signal to a baseband frequency.

7. The method of claim 1, further comprising:
routing the intermediate frequency signal through a low pass filter to generate a baseband signal.

8. A method comprising:
in response to a strength of a radio frequency signal, controlling a gain of an amplifier in a radio frequency section of a receiver; and
inversely varying a gain of an amplifier in an intermediate frequency section of the receiver with respect to a variation of the gain of the amplifier in the radio frequency section of the receiver.

9. The method of claim 8, wherein the strength comprises an in-band spectral power.

10. The method of claim 8, wherein the variation of the gain in the intermediate frequency section of the receiver substantially cancels the variation of the gain in the radio frequency section.

11. The method of claim 8, further comprising:
controlling a gain of at least one additional amplifier in the intermediate frequency section to regulate a strength of a baseband signal provided by the receiver.

12. The method of claim 8, wherein the act of inversely varying comprises:
controlling the gain of the amplifier in the intermediate frequency section and the gain of the amplifier in the radio frequency section with a control signal shared in common.

13. The method of claim 12, wherein said control signal shared in common comprises a signal indicative of an in-band spectral strength of the radio frequency signal.

14. A receiver comprising:
a radio frequency section comprising an amplifier to establish a gain in the radio frequency section in response to a strength of a radio frequency signal received by the RF section; and
an intermediate frequency section coupled to the RF section comprising an amplifier having a gain that inversely varies with respect to a variation in the gain of the amplifier in the radio frequency section.

15. The receiver of claim 14, wherein the strength comprises a in-band spectral power of the radio frequency signal.

16. The receiver of claim 14, wherein the variation of the gain in the intermediate frequency section substantially cancels the variation of the gain in the radio frequency section.

17. The receiver of claim 14, wherein the intermediate frequency section further comprises:
at least one additional amplifier to regulate a strength of a baseband signal provided by the receiver.

18. The receiver of claim 14, further comprising:
a gain control circuit to generate a signal to control both the gain of the radio frequency section and the gain of the amplifier in the intermediate frequency section.

19. A receiver associated with a first radio service provider, the receiver comprising:
a radio frequency section to determine the strength of spectral energy received from the first radio service provider and regulate a gain of a first amplifier of the radio frequency section in response to the determined strength, the determined strength capable of being in error due to reception of additional spectral energy associated with a second radio service provider; and
an intermediate frequency section comprising a second amplifier, the second amplifier having a gain that inversely varies with respect to a variation in the gain of the first amplifier to reduce an overall gain sensitivity of the receiver to said additional spectral energy associated with the second radio service provider.

20. The receiver of claim 19, wherein at least one of the first radio service provider and the second radio service provider comprises a satellite radio service provider.

21. The receiver of claim 19, further comprising:
a bandpass filter coupled between the radio frequency section and the intermediate frequency section.

22. The receiver of claim 19, wherein the radio frequency section comprises a mixer to translate a selected channel of the spectral energy received associated with the first satellite radio service provider to an intermediate frequency.

23. The receiver of claim 19, wherein the intermediate frequency section comprises a mixer to translate the intermediate frequency to a baseband frequency.

24. The receiver of claim 19, wherein the intermediate frequency section comprises at least one additional amplifier to regulate an overall gain of the intermediate frequency section.

25. The receiver of claim 24, further comprising:
a lowpass filter coupled to the intermediate frequency section to provide a baseband signal, wherein the overall gain of the intermediate frequency section is controlled in response to a strength of the baseband signal.

26. The receiver of claim 19, wherein the variation in the gain of the second amplifier substantially cancels the variation of the gain of the first amplifier.
